(19) United States
(12) Patent Application Publication
(10) Pub. No.: US 2013/0268663 A1
(43) Pub. Date: Oct. 10, 2013

(54) COMMUNICATION NETWORK SYSTEM

(71) Applicant: Tomoyuki Fujita, Chiyoda-ku (JP)

(72) Inventor: Tomoyuki Fujita, Chiyoda-ku (JP)

(73) Assignee: MITSUBISHI ELECTRIC CORPORATION, Chiyoda-ku, Tokyo (JP)

(21) Appl. No.: 13/993,160

(22) PCT Filed: Dec. 28, 2010
(86) PCT No.: PCT/JP2010/073757

§ 371 Date: Jun. 11, 2013

(51) Int. Cl. H04L 12/26

(52) U.S. Cl. CPC H04L 43/08
USPC 709/224

(57) ABSTRACT

A communication network system in which a plurality of communication stations are connected to perform sending to or receiving from each other, wherein each station includes one or more processing units, when the processing unit receives a request message including an instruction to measure a transient-transmission processing time, the processing unit stores a first time required for the processing unit to process the request message in a storage unit included in the processing unit, and sends the request message, and when the processing unit receives a response message that is a response to the request message including an instruction to measure a transient-transmission processing time, the processing unit stores a second time required between when the request message is sent and when the response message is received and a third time required for the processing unit to process the response message in the storage unit, and sends it.

### FIELD

The present invention relates to a communication network system having a function of measuring a transient-transmission processing time.

### BACKGROUND

Conventionally, the only method of verifying transient performance has been to measure a processing time between when a request message is sent and when the response message is received by means of a personal computer (user application) that is a request-message activating source. There is not any means for storing a processing time within a CPU and a network unit that relay a message. Therefore, in a case where there occurs a processing delay at any location where a message is relayed, the delay can be recognized as a delay of the whole transient transmission process, but it has been difficult to identify the location where the delay has occurred.

For example, there has been disclosed a technique for calculating a transient communication time in a bus management system that appropriately allocates a transmission time for which each of controller units uses a bus to each of the controller units. According to this technique, in the bus management system, a base unit calculates a transient-data transferring time corresponding to a slot time for each of the controller units (see, for example, Patent Literature 1).

As another example, there has been disclosed a technique for calculating a transient-transmission processing time in a network between PCs. Processing means for performing a standby time process start time check from the time of sending a transient request to a sequence control unit. When a process is not completed during an operation of the time check, the process is forcibly subjected to execution, and these standby times are summed to calculate an elapsed time during which all commands are executed (see, for example, Patent Literature 2). Furthermore, there has been disclosed a technique relating to a method of measuring a frame circulation time (see, for example, Patent Literature 3).

### CITATION LIST

### Patent Literatures

Patent Literature 1: Japanese Patent Application Laid-open No. 2006-318367

Patent Literature 2: Japanese Patent Application Laid-open No. 5-252166

Patent Literature 3: Japanese Patent Application Laid-open No. 2006-319490

### SUMMARY

### Technical Problem

However, according to the above conventional techniques, the only method of verifying transient performance is to measure a processing time between when a request message is transmitted and when the response message is received using a personal computer (user application) that is a request-message activating source. There is not any measure that stores a processing time within a CPU and a network unit that relay a message. Therefore, there is a problem that in a case where there occurs a processing delay at any location where a message is relayed, the delay can be recognized as a delay of the whole transient message process, but it is difficult to identify the location where the delay has occurred.

The present invention has been achieved in view of the above circumstances, and an object of the present invention is to provide a communication network system that can identify a location where a processing time is longer in transient transmission adapted to relay a plurality of networks, and therefore can reliably improve response performance of the transient transmission.

### Solution to Problem

In order to solve the above-mentioned problems and achieve the object, the present invention provides a communication network system in which a plurality of communication stations are connected to perform sending to or receiving from each other, wherein each of the communication stations includes one or more processing units, when the processing unit receives a request message including an instruction to measure a transient-transmission processing time, the processing unit stores a first time required for the processing unit to process the request message in a storage unit included in the processing unit, and sends the request message, and when the processing unit receives a response message that is a response to the request message including an instruction to measure a transient-transmission processing time, the processing unit stores a second time required between when the request message is sent and when the response message is received and a third time required for the processing unit to process the response message in the storage unit, and sends the response message.

### Advantageous Effects of Invention

According to the present invention, in transient transmission adapted to relay a plurality of networks, a location where a processing time is longer can be identified, and therefore response performance of the transient transmission can be properly improved.

### BRIEF DESCRIPTION OF DRAWINGS

FIG. 1 is a diagram showing a configuration of a communication network system according to an embodiment of the present invention.

FIG. 2 is a block diagram showing a configuration of a communication station according to the embodiment of the present invention.

FIG. 3 is a block diagram showing a configuration of another communication station according to the embodiment of the present invention.

FIG. 4 is a block diagram showing a configuration of still another communication station according to the embodiment of the present invention.

FIG. 5 is a chart showing times of measurement start time points and measurement end time points of a transient-transmission processing time in the embodiment of the present invention.

FIG. 6 is a chart showing a processing flow of measurements and recordings of a transient-transmission processing time in the embodiment of the present invention.

FIG. 7 is a chart showing a processing flow to read a measurement result of the transient-transmission processing time in the embodiment of the present invention.

FIG. 8 is a chart in a conventional art, showing a state in transient transmission where a transmission delay has occurred due occurrence of a retry.

### DESCRIPTION OF EMBODIMENTS

Exemplary embodiments of a communication network system according to the present invention will be described below in detail with reference to the drawings. The present invention is not limited to the embodiments.

### Embodiment

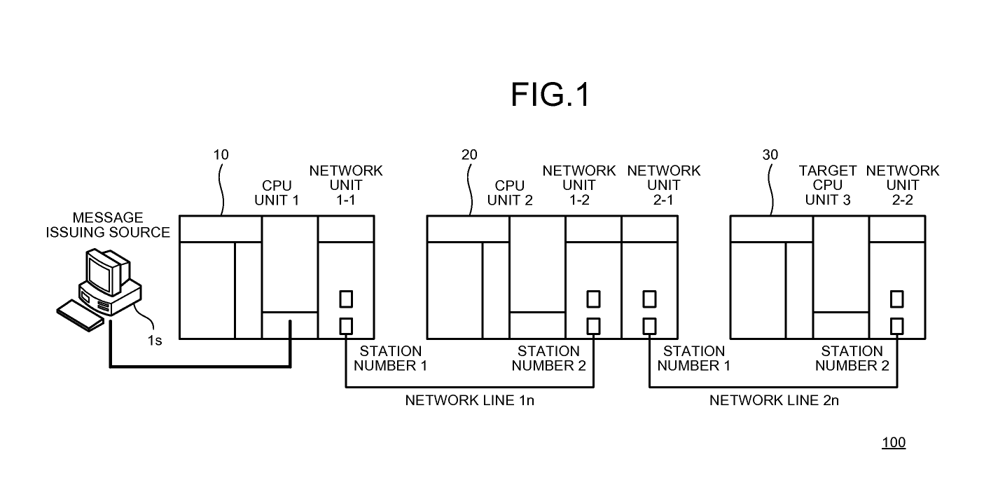

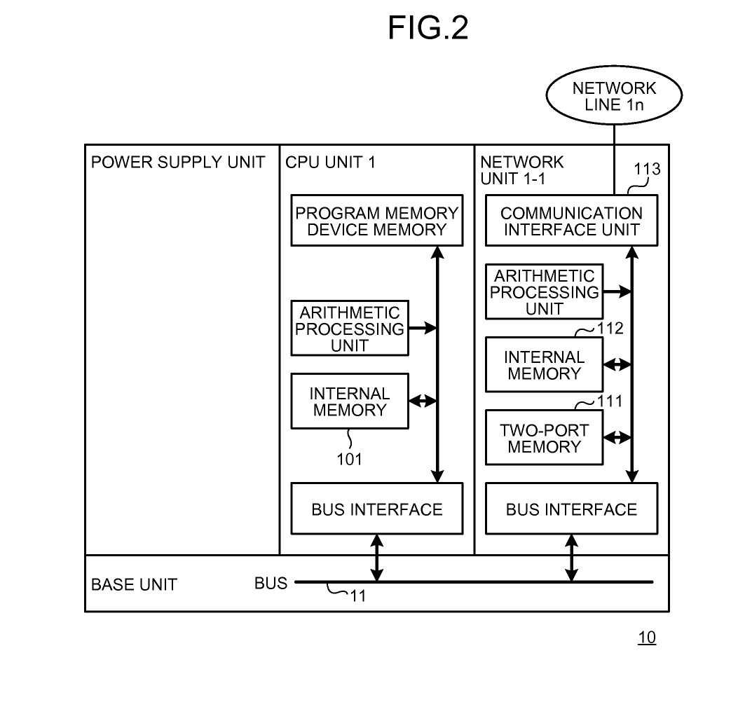

FIG. 1 is a diagram showing a configuration of a communication network system 100 according to an embodiment of the present invention. The communication network system 100 is constituted by a message issuing source 1 such as a personal computer (user application), and communication stations 10, 20 and 30. FIGS. 2 to 4 are block diagrams showing respective configurations of the communication stations 10, 20 and 30. The communication station 10 includes a CPU unit 1 and a network unit 1-1. The communication station 20 includes a CPU unit 2, a network unit 1-2, and a network unit 2-1. The communication station 30 includes a CPU unit 3 and a network unit 2-2.

Furthermore, the CPU unit 1 includes an internal memory 101. The network unit 1-1 includes a two-port memory 111, an internal memory 112, and a communication interface unit 113. The CPU unit 2 includes an internal memory 201. The network unit 1-2 includes a two-port memory 121, an internal memory 122, and a communication interface unit 123. The network unit 2-1 includes a two-port memory 211, an internal memory 212, and a communication interface unit 213. The CPU unit 3 includes an internal memory 301. The network unit 2-2 includes a two-port memory 221, an internal memory 222, and a communication interface unit 223.

An operation of each communication station according to the present embodiment is explained below.

First, an operation of the communication station 10 is explained with reference to FIG. 2. When the CPU unit 1 issues a command request message, the CPU unit 1 writes a desired command request message to be issued to the two-port memory 111 in the network unit 1-1 via a bus 11, and notifies the network unit 1-1 of an interrupt via the bus 11. When the network unit 1-1 receives the interrupt, the network unit 1-1 reads the command request message from the two-port memory 111, and adds a header for a transient frame in the communication interface unit 113 to send the transient frame onto a network line 1.

Meanwhile, when the network unit 1-1 in the communication station 10 receives a transient frame from the network line 1, the network unit 1-1 writes a command request message taken out from the transient frame in the communication interface unit 113 into the two-port memory 111, and notifies the CPU unit 1 of an interrupt via the bus 11. When the CPU unit 1 receives the interrupt, the CPU unit 1 reads the command message from the two-port memory 111 in the network unit 1-1 via the bus 11, performs a process according to contents of the command request, and returns a response message to the request of the command.

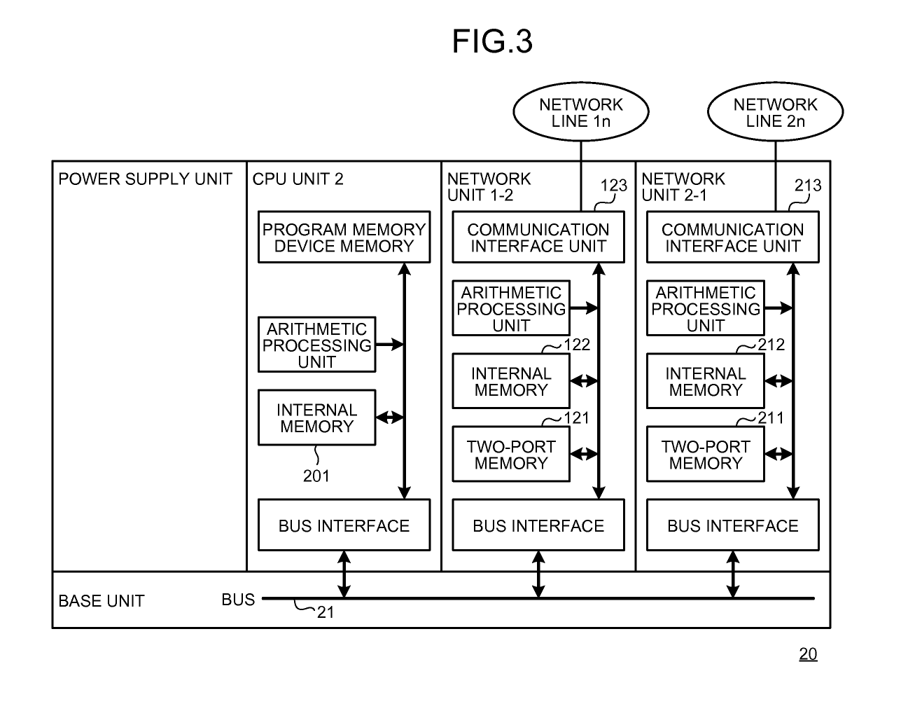

Next, an operation of the communication station 20 is explained with reference to FIG. 3. When the CPU unit 2 issues a command request message, the CPU unit 2 writes a desired command request message to be issued to the two-port memory 121 in the network unit 1-2 via a bus 21, and notifies the network unit 1-2 of an interrupt via the bus 21. When the network unit 1-2 receives the interrupt, the network unit 1-2 reads the command request message from the two-port memory 121, and adds a header for a transient frame in the communication interface unit 123 to send the transient frame onto the network line 1.

When the CPU unit 2 issues a command request message, the CPU unit 2 writes a desired command request message to be issued into the two-port memory 211 in the network unit 2-1 via the bus 21, and notifies the network unit 2-1 of an interrupt via the bus 21. When the network unit 2-1 receives the interrupt, the network unit 2-1 reads the command request message from the two-port memory 211, and adds a header for a transient frame in the communication interface unit 213 to send the transient frame onto a network line 2.

Then, when the network unit 1-2 in the communication station 20 receives a transient frame from the network line 1, the network unit 1-2 writes a command request message taken out from the transient frame in the communication interface unit 123 into the two-port memory 121, and notifies the CPU unit 2 of an interrupt via the bus 21. When the CPU unit 2 receives the interrupt, the CPU unit 2 reads the command message from the two-port memory 121 in the network unit 1-2 via the bus 21. When the command is addressed to its own station, the CPU unit 2 performs a process according to contents of the command request, and returns a response message to the request of the command. When the command is addressed to another station, the CPU unit 2 sends a message from the network unit 2-1 via the communication interface unit 213 to the network line 2 according to routing information the CPU unit 2 has. That is, the CPU unit 2 writes a command into the two-port memory 211 in the network unit 2-1, and issues an interrupt to the network unit 2-1.

Meanwhile, when the network unit 2-1 in the communication station 20 receives a transient frame from the network line 2, the network unit 2-1 writes a command request message taken out from the transient frame in the communication interface unit 213 into the two-port memory 211, and notifies the CPU unit 2 of an interrupt via the bus 21. When the CPU unit 2 receives the interrupt, the CPU unit 2 reads the command message from the two-port memory 211 in the network unit 2-1 via the bus 21. When the command is addressed to its own station, the CPU unit 2 performs a process according to contents of the command request, and returns a response message to the request of the command. When the command is addressed to another station, the CPU unit 2 sends the message from the network unit 1-2 via the communication interface unit 123 to the network line 1 according to routing information the CPU unit 2 has. That is, the CPU unit 2 writes a command into the two-port memory 121 in the network unit 1-2, and issues an interrupt to the network unit 1-2.

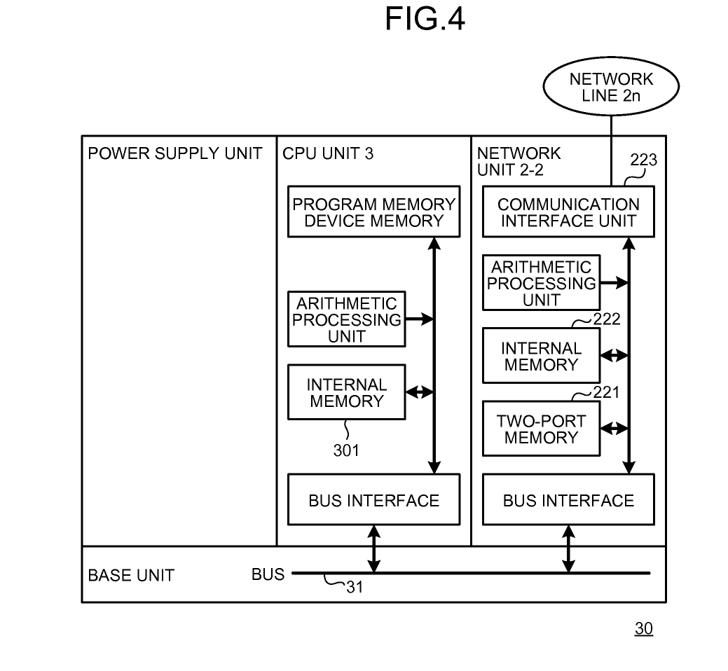

Furthermore, an operation of the communication station 30 is explained with reference to FIG. 4. When the CPU unit 3 issues a command request message, the CPU unit 3 writes a desired command request message to be issued into the two-port memory 221 in the network unit 2-2 via a bus 31, and notifies the network unit 2-2 of an interrupt via the bus 31. When the network unit 2-2 receives the interrupt, the network unit 2-2 reads the command request message from the two-port memory 221, and adds a header for a transient frame in the communication interface unit 223 to send the transient frame onto the network line 2.

Meanwhile, when the network unit 2-2 in the communication station 30 receives a transient frame from the network line 2, the network unit 2-2 writes a command request message taken out from the transient frame in the communication interface unit 223 into the two-port memory 221, and notifies the CPU unit 3 of an interrupt via the bus 31. When the CPU unit 3 receives the interrupt, the CPU unit 3 reads the command message from the two-port memory 221 in the network unit 2-2 via the bus 31, performs a process according to contents of the command request, and returns a response message to the request of the command.

In addition to the above operations, in the present embodiment, when processing units that are the CPU unit 1, the network unit 1-1, the network unit 1-2, the CPU unit 2, the network unit 2-1, the network unit 2-2, and the CPU unit 3 receive a request message including an instruction to measure a transient-transmission processing time, for example, receive a request message in which a flag bit indicating an instruction to measure a transient-transmission processing time is ON, the processing units store amounts of time required for the respective processing units to process the request message in the internal memories 101, 112, 122, 201, 212, 222 and 301 that are storage units included in the processing units.

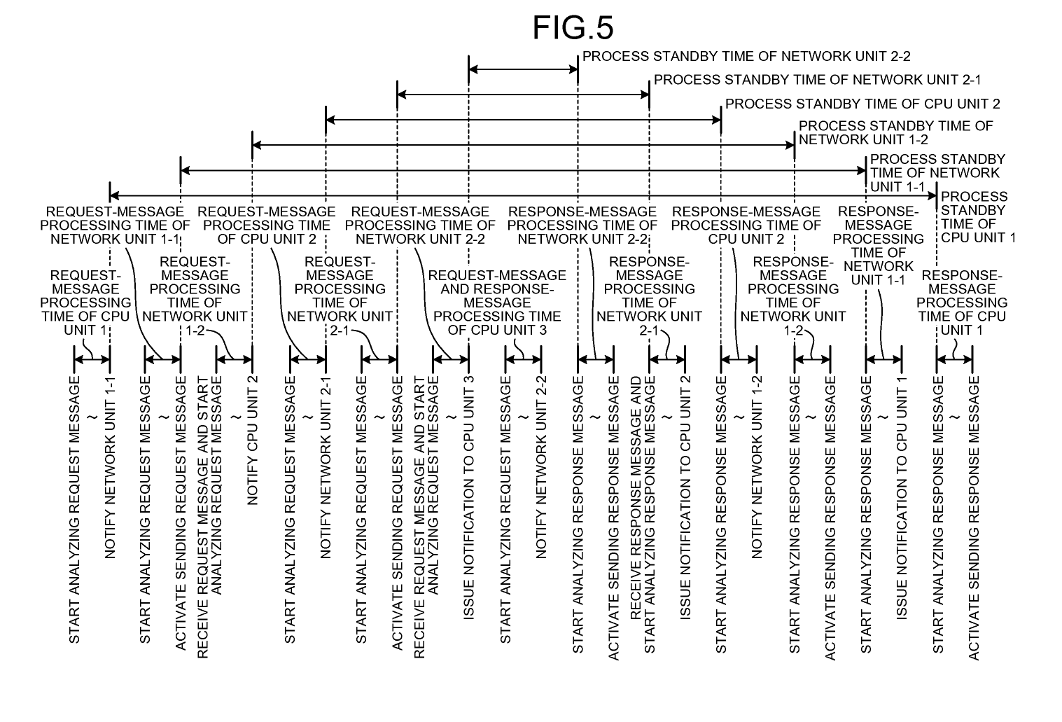

As shown in FIG. 1, in a case where the processing units are relay units such as the CPU unit 1, the network unit 1-1, the network unit 1-2, the CPU unit 2, the network unit 2-1, and the network unit 2-2, the processing units store the amounts of time between when the process is started and when a request message is analyzed in the respective processing units and another one of the processing units is notified of the request message in the internal memories 101, 112, 122, 201, 212 and 222 as amounts of time required for the respective processing units to process the request message. These amounts of time are a request-message processing time of the CPU unit 1, a request-message processing time of the network unit 1-1, a request-message processing time of the network unit 1-2, a request-message processing time of the CPU unit 2, a request-message processing time of the network unit 2-1, and a request-message processing time of the network unit 2-2, respectively, as shown in FIG. 5.

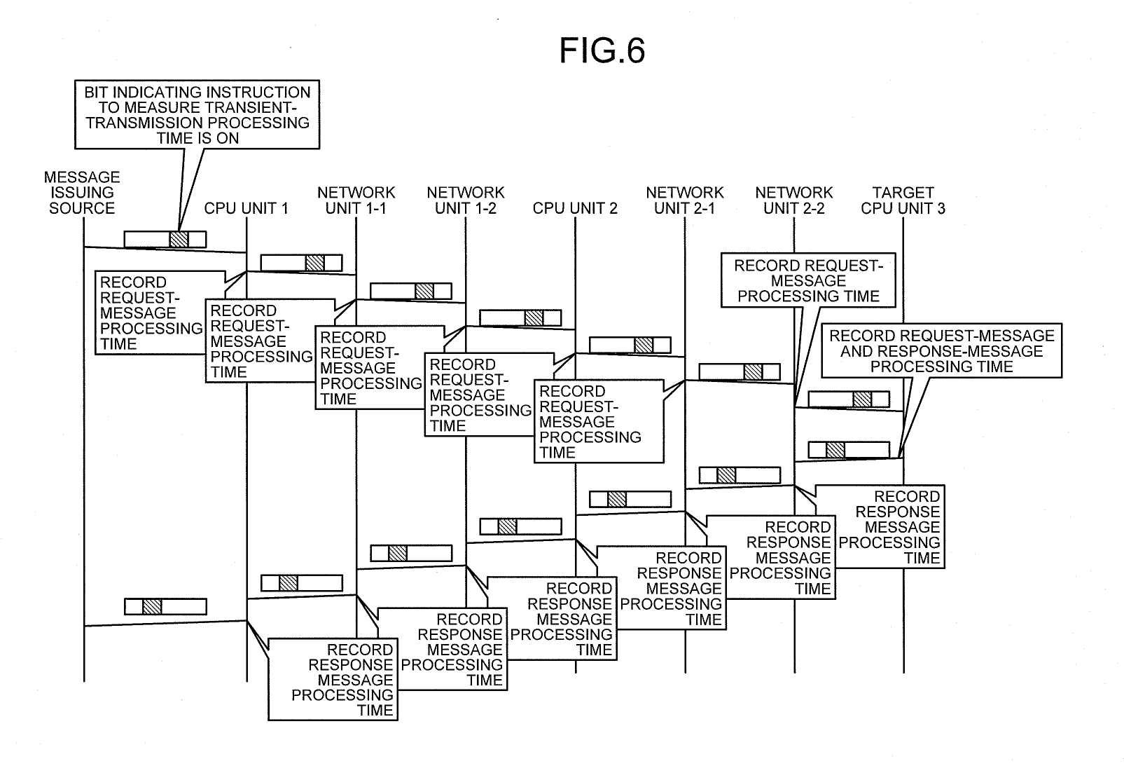

Furthermore, in a case where the processing unit is a target unit to which a request message is delivered, such as the CPU unit 3, the processing unit stores an amounts of time between when the process is started and when the request message is analyzed in the processing unit and the process is completed in the processing unit, in the internal memory 301 as an amount of time required for the processing unit to process the request message. This amount of time constitutes a part of a request-message and response-massage processing time of the CPU unit 3 shown in FIG. 5. FIG. 6 depicts a processing flow to record the request-message processing time explained above.

Further, in the present embodiment, when processing units that are the CPU unit 1, the network unit 1-1, the network unit 1-2, the CPU unit 2, the network unit 2-1, the network unit 2-2, and the CPU unit 3 receive a response message including an instruction to measure a transient-transmission processing time, for example, receive a response message in which a flag bit indicating an instruction to measure a transient-transmission processing time is ON, the processing units store amounts of time required for the respective processing units to process the response message in the internal memories 101, 112, 122, 201, 212, 222 and 301 that are storage units included in the respective processing units. A response message including an instruction to measure a transient-transmission processing time is a response message responding to a request message including an instruction to measure a transient-transmission processing time.

In a case where the processing unit is a target unit to which a request message is delivered, such as the CPU unit 3, the processing unit stores an amount of time between when the process is started and when a response message is created in the processing unit and another one of the processing units is notified of the response message in the internal memory 301 as an amount of time required for the processing unit to process the response message. This time is added to the time required for the CPU unit 3 to process the request message, which has been already stored in the internal memory 301, thereby obtaining the request-message and response-message processing time of the CPU unit 3 shown in FIG. 5. Therefore, the request-message and response-message processing time of the CPU unit 3, that is a total value of them may be stored in the internal memory 301.

In a case where the processing units are relay units such as the network unit 2-2, the network unit 2-1, the CPU unit 2, the network unit 1-2, the network unit 1-1, and the CPU unit 1, the processing units store amounts of time between when the process is started and when a response message is analyzed in the respective processing units and another one of the processing units is notified of the response message in the internal memories 222, 212, 201, 122, 112 and 101 as amounts of time required for the respective processing units to process the response message. These times are a response-message processing time of the network unit 2-2, a response-message processing time of the network unit 2-1, a response-message processing time of the CPU unit 2, a response-message processing time of the network unit 1-2, a response-message processing time of the network unit 1-1, and a response-message processing time of the CPU unit 1, respectively, as shown in FIG. 5. FIG. 6 also depicts a processing flow to record the request-message and response-message processing time and the response-message processing time that are explained above.

Furthermore, in the present embodiment, when processing units that are the network unit 2-2, the network unit 2-1, the CPU unit 2, the network unit 1-2, the network unit 1-1, and the CPU unit 1 receive a response message including an instruction to measure a transient-transmission processing time, for example, receive a response message in which a flag bit indicating an instruction to measure a transient-transmission processing time is ON, the processing units store amounts of time required between when the respective processing units send request messages including an instruction to measure a transient-transmission processing time and when the respective processing units receive response messages that correspond to and pair up with the request messages in the internal memories 222, 212, 201, 122, 112 and 101 that are storage units included in the respective processing units.

That is, processing units that are the network unit 2-2, the network unit 2-1, the CPU unit 2, the network unit 1-2, the network unit 1-1, and the CPU unit 1 store amounts of time between when a process of a request message that pairs up with a response message including an instruction to measure a transient-transmission processing time is completed and when the response message is received, in the internal memories 222, 212, 201, 122, 112 and 101, respectively, as the amounts of time required between when a request message is sent and when a response message that responds to it and pairs up with the request message is received. These times are a process standby time of the network unit 2-2, a process standby time of the network unit 2-1, a process standby time of the CPU unit 2, a process standby time of the network unit 1-2, a process standby time of the network unit 1-1, and a process standby time of the CPU unit 1, respectively, as shown in FIG. 5.

In place of storing the request-message processing time, the response-message processing time, and the process standby time that are explained above, a start time point and an end time point of those periods of time shown in FIG. 5 may be stored in storage units included in the respective processing units.

In this manner, the request-message processing time, the response-message processing time, and the process standby time are stored in the internal memories 101, 112, 122, 201, 212, 222 and 301 that are storage units included in respective processing units that are the CPU unit 1, the network unit 1-1, the network unit 1-2, the CPU unit 2, the network unit 2-1, the network unit 2-2, and the CPU unit 3, and thereafter, reading out of a measurement result of a transient-transmission processing time is performed.

That is, when processing units that are the CPU unit 1, the network unit 1-1, the network unit 1-2, the CPU unit 2, the network unit 2-1, the network unit 2-2, and the CPU unit 3 receive a request message including a request to read a measurement result of a transient-transmission processing time or a response message that is a response to the request message, the processing units add the request-message processing time, the response-message processing time, and the process standby time that are stored in the internal memories 101, 112, 122, 201, 212, 222 and 301 to the response message and send this response message. A request message including a request to read a measurement result of a transient-transmission processing time or a response message that is a response to the request message is, for example, a request message in which a flag bit indicating a request to read a measurement result of a transient-transmission processing time is ON or a response message that is a response to the request message.

Specifically, in a case of the communication station 20 in FIG. 3 for example, when the network unit 2-1 receives a message including a request to read a measurement result of a transient-transmission processing time, the network unit 2-1 notifies the CPU unit 2 of the message including a request to read a measurement result of a transient-transmission processing time.

The CPU unit 2 returns a response message to which the request-message processing time and response-message processing time held in the internal memory 201 are written and added, via the network unit 2-1, when the message including a request to read a measurement result of a transient-transmission processing time is addressed to its own station. When the message including a request to read the measurement result is addressed to another station, the CPU unit 2 sends the message from, for example, the network unit 1-2 that is another network unit according to routing information the CPU unit 2 has. In a case where the message including a request to read the measurement result is a response message, the CPU unit 2 transmits a response message to which a process standby time required between when a request message is sent and when a response message is received is written and added in addition to the request-message processing time and the response-message processing time, from the network unit 1-2.

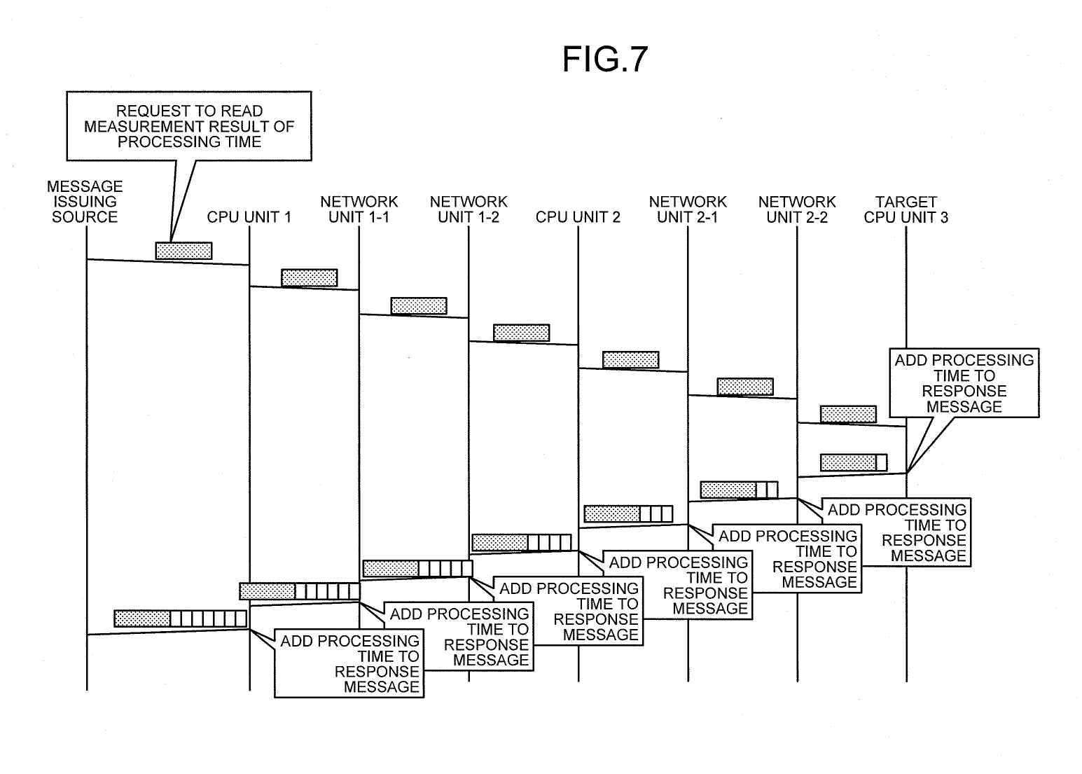

In this manner, when processing units that are the CPU unit 3, the network unit 2-2, the network unit 2-1, the CPU unit 2, the network unit 1-2, the network unit 1-1, and the CPU unit 1 receive a response message including a request to read a measurement result of a transient-transmission processing time, the processing units add the request-message processing time, the response-message processing time, and the process standby time that are held in the internal memories 301, 222, 212, 201, 122, 112 and 101 included in the respective processing units to the response message and return the resultant response message by a flow shown in FIG. 7.

As explained above, the communication network system according to the present embodiment is effective for transient transmission using a plurality of communication stations, which is adapted to relay a plurality of networks. That is, a CPU unit and a network unit that constitute each communication station that is a communication node of the communication network system have the following function. When the CPU unit and the network unit receive a request message and a response message that include an instruction to measure a transient-transmission processing time, for example, receive a request message and a response message in which a flag bit indicating an instruction to measure a transient-transmission processing time is ON, the CPU unit and the network unit store the amounts of time spent to process the request message and the response message within the respective units in memory areas in their own units, and relay the request message and the response message.

The CPU unit and the network unit also have the following function. After relaying the request message and the response message, when the CPU unit and the network unit receive a message including a request to read a measurement result of a transient-transmission processing time, for example, a message in which a flag bit indicating a request to read a measurement result of a transient-transmission processing time is ON, the CPU unit and the network unit add information concerning a processing time of a request message and a response message, which have been stored in the memory areas within their own units, and also a process standby time required between when the request message is sent and when the response message is received to the response message, and relay this response message.

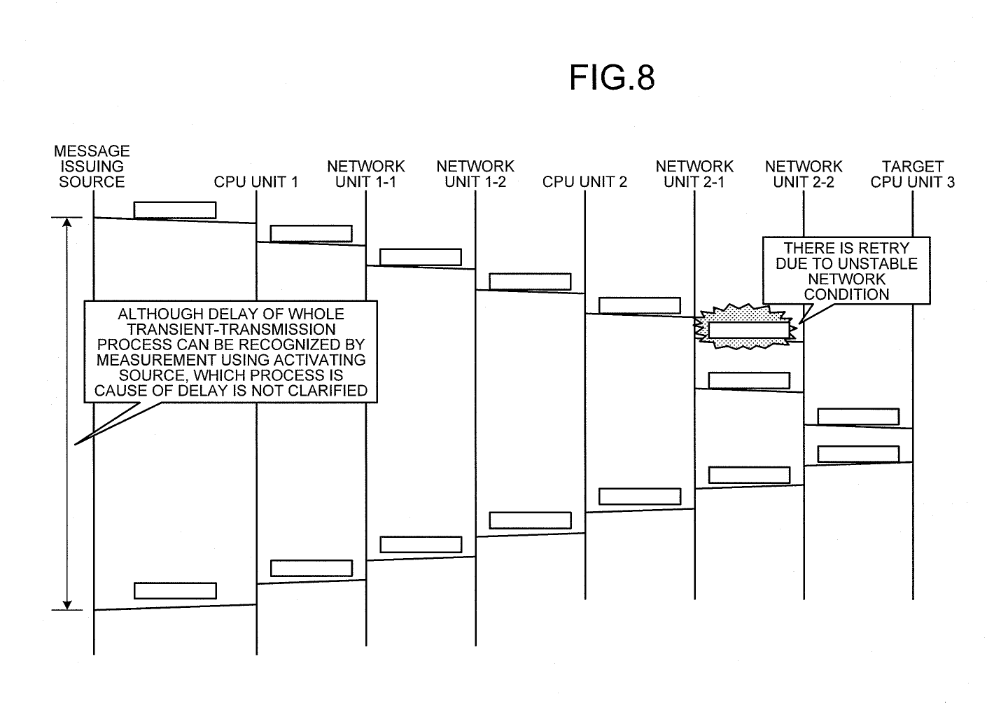

Conventionally, the only method for a network administrator to verify transient performance in a large network system that relays a message through a plurality of networks as shown in FIG. 1 has been to measure a processing time between when a request message is sent and when a response message is received using a personal computer (user application) that is a request-message activating source, as shown in FIG. 8. There had not been any means for storing a processing time within a CPU unit and a network unit that relay a message. That is, in a case where there occurs a retry at any location where a message is relayed due to an unstable network condition, thereby causing a processing delay, it has been difficult to identify the location where the delay has occurred.

In the present embodiment, internal processing times of a CPU unit and a network unit that relay a message can be recorded and referred to. Therefore, it is possible to identify a relay process in which a processing delay has occurred by comparing the respective processing times with each other. Accordingly, it is possible to properly improve response performance of transient transmission.

Furthermore, a request message in which measurement of a processing time is desired and a message having a measurement result stored therein are separate messages, and thereby the length of each of the request message in which the measurement is desired and the response message is the same as the length of a conventional message. Therefore, it is possible to suppress the influence of a measurement process on the processing time.

The invention of the present application is not limited to the embodiment described above, and when the present invention is carried out, the invention can be variously modified without departing from the scope thereof. The embodiment described above involves inventions of various levels, and various inventions can be extracted by appropriately combining a plurality of constituent elements disclosed therein.

For example, even when some constituent elements are omitted from all constituent elements mentioned in the embodiment described above, the configuration from which these constituent elements have been omitted can be extracted as an invention as far as it can solve the problems mentioned in the section of Technical Problem and obtain effects mentioned in the section of Advantageous Effects of Invention. Furthermore, constituent elements in the embodiment described above may be appropriately combined.

### INDUSTRIAL APPLICABILITY

As described above, the communication network system according to the present invention is useful for a communication network that relays a message through a plurality of networks, and is particularly suitable for improving response performance of transient transmission through a plurality of networks. Reference Signs List

10, 20, 30 communication station

11, 21, 31 bus

101, 112, 122, 201, 212, 222, 301 internal memory

111, 121, 211, 221 two-port memory

113, 123, 213, 223 communication interface unit

1. A communication network system in which a plurality of communication stations are connected to perform sending to or receiving from each other, wherein
each of the communication stations includes one or more processing units,
when the processing unit receives a request message including an instruction to measure a transient-transmission processing time, the processing unit stores a first time required for the processing unit to process the request message in a storage unit included in the processing unit, and sends the request message, and
when the processing unit receives a response message that is a response to the request message including an instruction to measure a transient-transmission processing time, the processing unit stores a second time required between when the request message is sent and when the response message is received and a third time required for the processing unit to process the response message in the storage unit, and sends the response message.

2. The communication network system according to claim 1, wherein when the processing unit receives a second request message including a request to read a measurement result of a transient-transmission processing time or a second response message that is a response to the second request message, the processing unit adds the first time, the second time, and the third time that are stored in the storage unit to the second response message, and sends the second response message.

3. The communication network system according to claim 1, wherein each of the communication stations includes a plurality of the processing units.

4. The communication network system according to claim 3, wherein
the communication station includes
a CPU unit that serves as the processing unit, and
a network unit that serves as another one of the processing units and includes a communication interface unit.

5. The communication network system according to claim 2, wherein each of the communication stations includes a plurality of the processing units.
